(19) United States
(12) Patent Application Publication
(10) Pub. No.: US 2015/0103983 A1
(43) Pub. Date: Apr. 16, 2015

(54) PERSONAL TELEPHONE RECEPTIONIST

(71) Applicant: Cordon LLC, Washington, DC (US)

(72) Inventor: Paul Kilmer, Washington, DC (US)

(21) Appl. No.: 14/514,605

(22) Filed: Oct. 15, 2014

Related U.S. Application Data
(60) Provisional application No. 61/891,793, filed on Oct. 16, 2013.

(51) Int. Cl. H04M 3/436; H04M 3/493

(52) U.S. Cl. CPC H04M 3/4365; H04M 3/493; H04M 2203/2038
USPC 379/88.01

(57) ABSTRACT

An application and process for a mobile electronic device having a speaker, a visual display and a keypad, comprising a receptionist routine to screen an incoming call from a calling party to a receiving party, said routine functioning to receive said incoming call, inquire of and receive information from the calling party, transmit the information to the receiving party, and provide multiple, user-selectable options to the receiving party for handling the incoming call.

This application claims priority to U.S. Provisional Application Ser. No. 61/891,793, filed on Oct. 16, 2013, the contents of which are herby incorporated by reference in their entirety.

### FIELD

This invention relates to a program or application for screening incoming electronic communications, such as telephone calls, of a receiving party.

### BACKGROUND

With the advent of cellular communications, many cellular (mobile) telephone users have opted to eliminate their conventional land line telephones in favor of mobile phones, especially cellular phones. While this is a great convenience, some annoying problems remain. More and more frequently unwanted telephone calls are received by the cellular telephone user, such as solicitation calls. While most cellular telephones have recognition software which enables identification of the incoming caller's telephone number and even their identity, there are also programs which enable such callers to block their identification information. Likewise, if an incoming call is from a desired source, but the receiving party/user has not yet linked an identity to the incoming telephone number, there is a chance that the user will not answer an important or desired call due to failure of the cellular telephone to display the identity of the caller.

It would be desirable to have a technique for screening incoming calls, especially those having blocked identities or unknown numbers, without having to answer directly or automatically send the incoming call to voicemail.

Several prior art patents have endeavored to address one or more of the above-mentioned drawbacks, problems, or limitations.

U.S. Pat. No. 7,245,713 to Simpson et al. discloses methods and systems for monitoring calls routed to a telephone network-based voice mail system. When a subscriber receives a telephone call, a determination is made as to whether the call should be routed to the voice mail system. If call monitoring services are activated, a three-way communication is set up between the calling party, the voice mail system and the subscriber. The subscriber is bridged into the call on a listen-only basis, but upon command by the subscriber, the subscriber may answer the call.

U.S. Pat. No. 7,158,619 to Simpson discloses methods and systems for monitoring calls routed to a telephone network voice mail system from a variety of remote telephone locations. When a subscriber receives a telephone call, a determination is made as to whether the subscriber's line is busy or whether the call goes unanswered. If remote call monitoring services are activated, a three-way communication is set up between the calling party, the voice mail system and the subscriber via a remote call monitoring directory number provided by the subscriber. The subscriber is patched into the call on a listen-only basis, but upon command by the subscriber, the subscriber may answer the call. The subscriber may set up a number of remote call monitoring filters, including an “always monitor” list, a “never monitor” list, and a schedule of days or times during which the subscriber allows or excludes remote call monitoring. Remote call monitoring services may be provided by a telephone services provider that is independent from the subscriber's home telephone services provider.

U.S. Published Patent Application No. 2009/0022285 to Swanburg et al. discloses a voicemail receptionist system which includes a memory and a processor. The memory can store data relating to one or more users. An incoming communication can be handled by the voicemail receptionist system and provided with functionality based upon a user's preferences, for example. The data stored by the voicemail receptionist system can be updated at any time, or automatically updated upon updating of the data, or upon occurrence of a trigger event. Voicemail receptionist functionality can include standard voicemail system functionality as well as functionality relating to email, text messaging, MMS messaging, calendar features, schedule transmitments, location data, as well as other features.

U.S. Pat. No. 8,041,014 to Daily et al. discloses a system and method for selectively answering incoming telephone calls based on a caller ID. Selected calls may be handled with a number of call handling functions including an auto-answer function, a custom message function, and a custom call forwarding.

U.S. Published Patent Application No. 2009/0189971 to Yoder discloses methods and apparatus for an interactive automated receptionist system according to various aspects of the invention may operate in conjunction with a computer system configured to connect to a network. The computer system may control a user interface that responds to an individual seeking assistance. The computer system may interactively prompt the individual to make a selection from a set of available assistance options. The computer system may receive a request from the individual to communicate with a party, and the computer system may accommodate the individual's selections, such as by establishing a communicative link between the individual and the selected party.

U.S. Published Patent Application No. 2010/0105446 to Charlier et al. discloses a wireless hands-free device operable to communicate with a mobile communication device over a short-range wireless link. The hands-free device includes a transceiver, a memory, a delayed answering mode actuator (DAMA), and a processing device. The transceiver is operable to receive incoming call information from the mobile device over the short-range link. The incoming call information corresponds to an incoming call received by the mobile device over a wireless wide area network. The memory is operable to store one or more pre-recorded audio messages. The DAMA is activatable by a user of the hands-free device. The processing device is operable to: detect activation of the DAMA after receipt of the incoming call information, retrieve at least one pre-recorded audio message responsive to detecting activation of the DAMA, and provide the retrieved, pre-recorded audio message(s) to the transceiver for subsequent transmission to the mobile device over the short-range link.

However, none of these technologies enables a cellular telephone user to screen incoming telephone calls from callers in real time, and select how to address or direct the call.

### SUMMARY

In one aspect, the invention resides in a process for screening an incoming call sent to a receiving party's mobile electronic device, comprising: receiving an incoming call sent by a calling party to the receiving party's mobile electronic device; switching the incoming call to an audio receptionist routine, programmed to inquire as to the identity of, and receive and transmit to the receiving party information from the calling party; the programmed audio receptionist routine providing the information to the receiving party; and providing the receiving party's mobile electronic device with multiple, user-selectable options for handling the incoming call.

In one embodiment of the process, the mobile electronic device can be a mobile telephone.

Conveniently according to the process, the multiple user-selectable options include answering the incoming call or sending the incoming call to voicemail.

Additionally according to the process, the multiple, user-selectable options include answering the incoming call, sending the incoming call to voicemail or terminating the incoming call.

In another embodiment, the multiple, user-selectable options include conferencing the incoming call with an ongoing call.

More particularly, according to the process the audio receptionist routine audibly inquires as to the name of the calling party, and/or the audio receptionist audibly inquires as to the nature of the calling party's business.

In a further embodiment of the process, the audio receptionist routine transmits, preferably in real-time, the information audibly to the receiving party, and/or the audio receptionist routine transmits, preferably in real time, the information to the receiving party in a textual format on a display screen.

Conveniently according to the process, the multiple, user-selectable options can be displayed on a display screen.

In one preferred embodiment of the process, the program for the audio receptionist routine can be resident in the mobile electronic device or can be downloadable into the mobile electronic device.

In another embodiment the present invention is directed to an application for a mobile electronic device having a speaker, a visual display and a keypad, comprising a receptionist program routine to screen an incoming call from a calling party to a receiving party, said routine functioning to receive said incoming call, inquire of and receive information from the calling party, transmit the information to the receiving party, and provide multiple, user-selectable options to the receiving party for handling the incoming call.

In a preferred aspect of this embodiment, the display of the mobile electronic device displays the multiple, user-selectable options, and the receptionist routine directs the incoming call according to selection of one of said options by the receiving party.

In another embodiment, the receptionist routine can be selected by the user to engage a receptionist mode to all incoming calls, to some incoming calls or to no incoming calls.

Conveniently, the receptionist routine inquiry can be a pre-programmed message or a custom programmed message, or the receptionist routine inquiry message can be downloaded from a website for use in a mobile device.

Additionally, the receptionist routine further comprises a speech recognition routine, either resident in the application or accessed from another application, to convert verbal information received from the calling party into text for visual display to the receiving party.

In one important embodiment, the application can be downloadable by a user, or alternatively the application can be pre-programmed into the mobile electronic device.

Advantageously, the receptionist routine can be structured and arranged to receive a second incoming call during the first incoming call and conference the calls together, and/or to receive a second incoming call during the first incoming call and to allow the receiving party to terminate the first incoming call and answer the second incoming call, and/or to receive a second incoming call during the first incoming call and to allow the receiving party to send the second incoming call to a voicemail system without terminating the first incoming call.

### BRIEF DESCRIPTION OF THE DRAWINGS

The following figures, in combination with the detailed description below, serve to further illustrate various embodiments in accordance with the present invention, but should not be considered to limit the invention in any way.

FIG. 1 is a block diagram of the flowpath of one embodiment of the present invention.

FIG. 2 is an example of a layout of on-screen options at receipt of a call in one embodiment of the invention.

FIG. 3 is an example of a layout of on-screen indication when the receptionist is engaged and delivering a greeting.

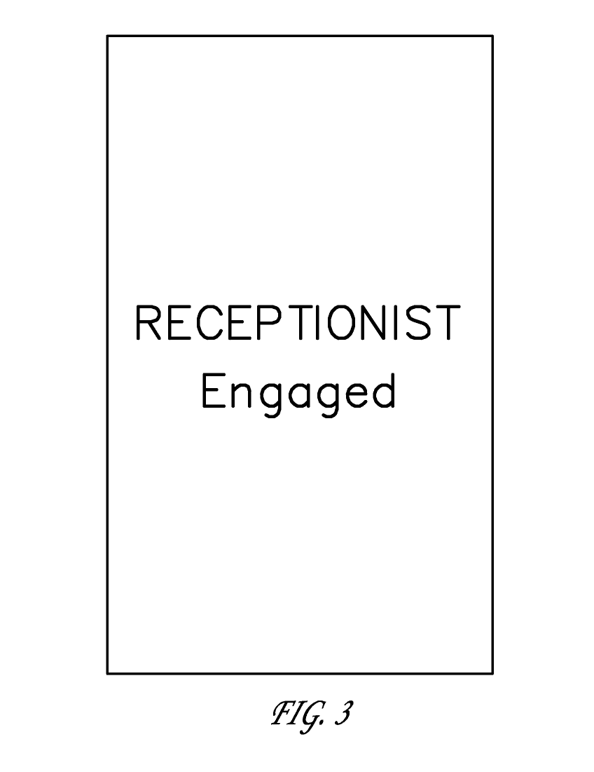

FIG. 4 is an example of on-screen options after the receptionist has delivered the greeting and the caller has identified himself.

FIG. 5 is an example of an on-screen options menu for selecting different greetings.

FIG. 6 is an example of an on-screen options menu for locating optional greetings online.

FIG. 7 is an example of an on-screen layout of search results for the optional greeting.

FIG. 8 is an example of an on-screen option to preview the selected greeting option.

FIG. 9 is an example of an on-screen option to download a selected greeting.

FIG. 10 is an example of an on-screen menu according to a second embodiment of the present invention.

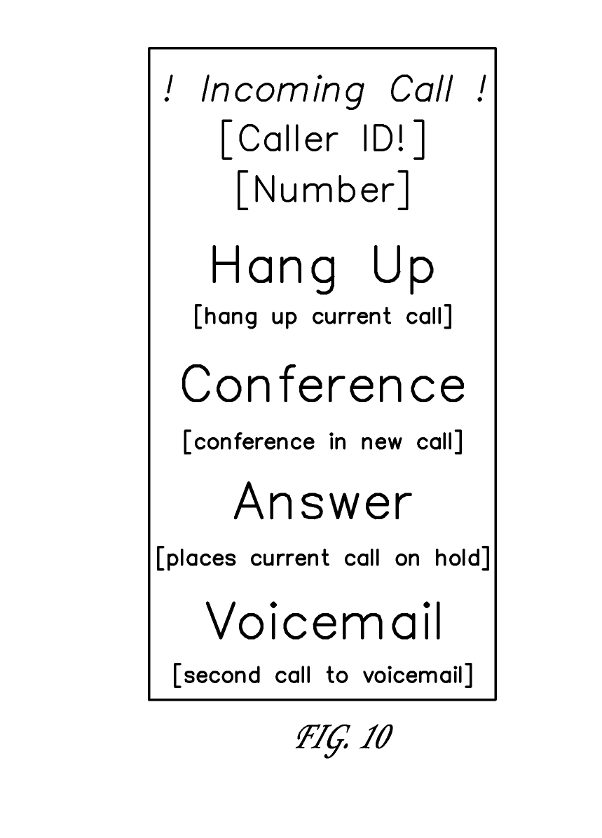

### DETAILED DESCRIPTION OF THE EMBODIMENTS

Described herein is a program or application and process for screening incoming electronic communications, such as telephone calls, of a receiving party.

Currently, mobile electronic communication devices can frequently identify either or both of the telephone number and the identity of the caller. However, there are many instances when such identification fails, such as when either the name or telephone number of the caller is not known or recognized by the receiving party, or when the incoming telephone number is blocked by the caller. In such circumstances the receiving party is left with a dilemma as to whether to answer the call or to permit the call to pass to a voicemail system or the like. This is especially troublesome when the receiving party is expecting a call from a first time caller whose identity and telephone number is not yet known, and therefore might not be immediately identifiable by the receiving party. Since such calls can be important, the receiving party risks missing the call due to inadequate information regarding the identity of the caller.

Likewise, there are commonly instances in which the receiving party wishes to avoid the caller. For example, there are many unwanted “robo-calls” which are difficult to avoid, as well as sales calls by callers who have in some manner obtained the receiving party's private cellular phone number, and obviously in some instances callers who, while known to the receiving party, are not welcome to call.

In the past, especially in the business climate, incoming telephone calls were typically screened by a central receptionist, who inquired as to the identity of the calling party to whom the caller wanted to speak and as to the nature of the caller's business. With the advent of mobile communications this useful function has been largely lost. The present invention is directed to a mobile communications application which restores this useful function for the receiving party.

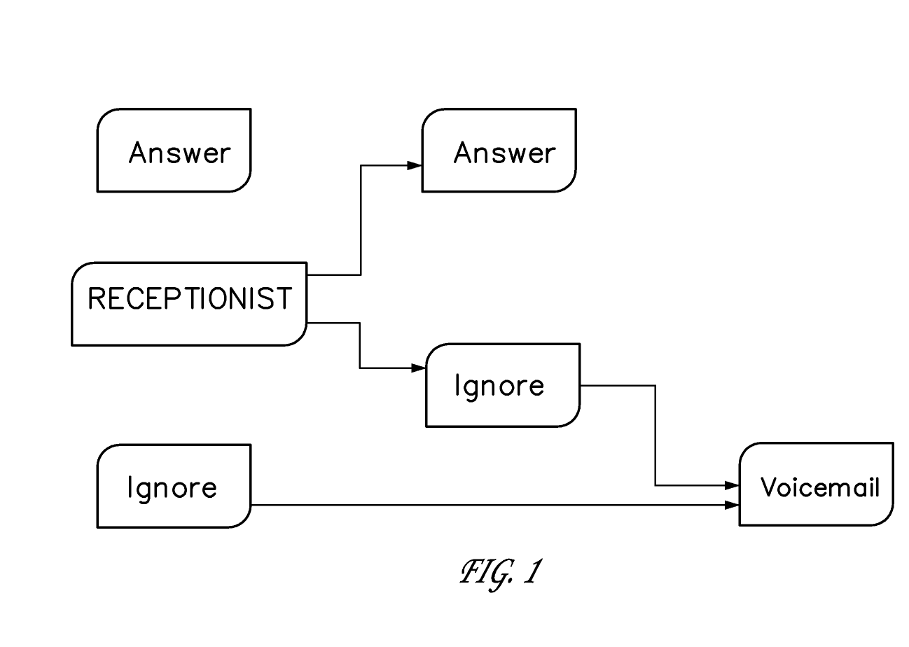

In a first embodiment the invention resides in a process for screening an incoming call sent to a receiving party's mobile electronic device, comprising receiving an incoming call sent by a calling party to the receiving party's mobile electronic device, switching the incoming call to an audio receptionist routine, programmed to inquire as to the identity of, and receive and transmit to the receiving party information from the calling party, the programmed audio receptionist routine providing the information to the receiving party, and providing the receiving party's mobile electronic device with multiple, user-selectable options for handling the incoming call. FIG. 1 is a block diagram illustrating the general flowpath of a simple embodiment of the presently described process.

Hereinafter the term “mobile electronic device” means an electronic device having at least a memory and a processor capable of executing commands provided by software, firmware or other such programmed routine. Examples of such devices include but are not limited to mobile telephones, especially smart phones, laptop computers and tablet computers. Typically, the mobile electronic device is a smart phone, but can also include any electronic medium, portable or not, on which it is desired to screen incoming voice data in real time.

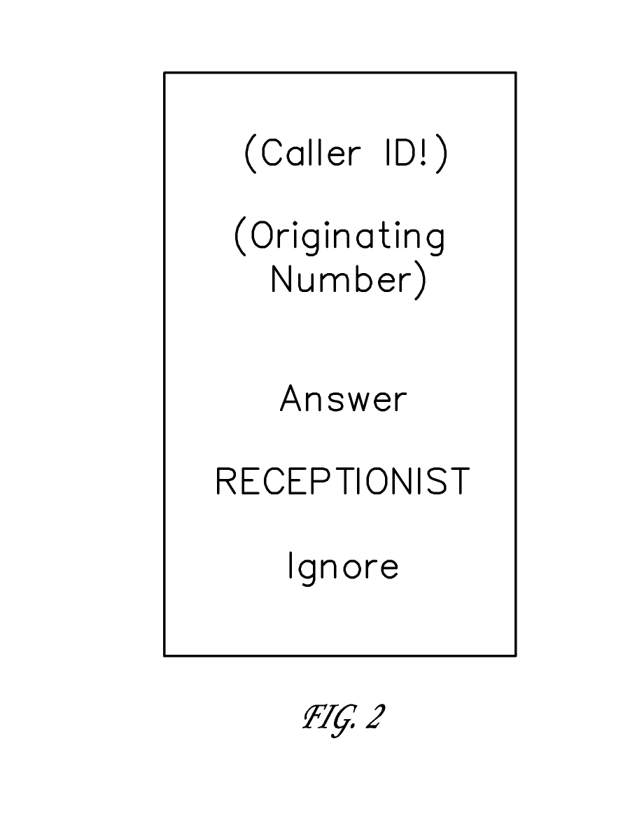

According to the process, there are provided to the receiving party's telephone screen multiple user-selectable options, which can include answering the incoming call or sending the incoming call to voicemail. For example, FIG. 2 illustrates a layout of on-screen options at the time of the receipt of a call. The options menu provides the receiving party with the caller ID and originating number, if available, and the option to answer, ignore or send the call to a programmed receptionist routine. If the receptionist routine is selected, the caller will receive a recorded greeting, such as “Who shall I say is calling?” and optionally “Please state your business with [the receiving party]” or the like, during which time the receiving party will observe a screen output such as illustrated in FIG. 2, indicating that the receptionist function is engaged.

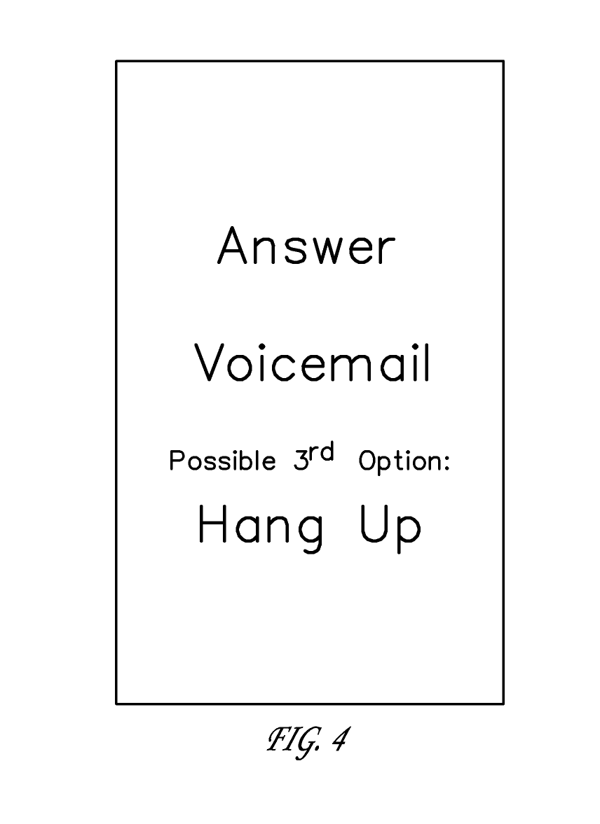

After receiving the incoming call, the audio receptionist routine transmits, preferably in real-time, the information audibly to the receiving party. Optionally, the receptionist routine further comprises a speech recognition routine, either resident in the application or accessed from another application, to convert verbal information received from the calling party into text for visual display to the receiving party, such that it can transmit, preferably in real-time, the information to the receiving party in a textual format on a display screen. During this period the receiving party is provided with a menu screen providing multiple user-selectable options including answering the incoming call or sending the incoming call to voicemail, or even terminating the incoming call, as illustrated in FIG. 4. In another embodiment, the user-selectable options can include an option to conference in the incoming call with an existing and ongoing call.

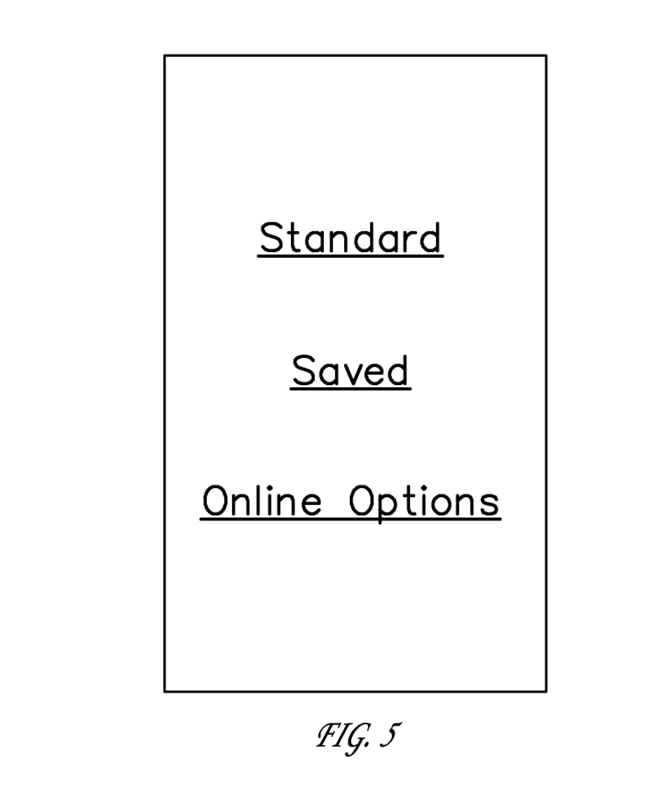

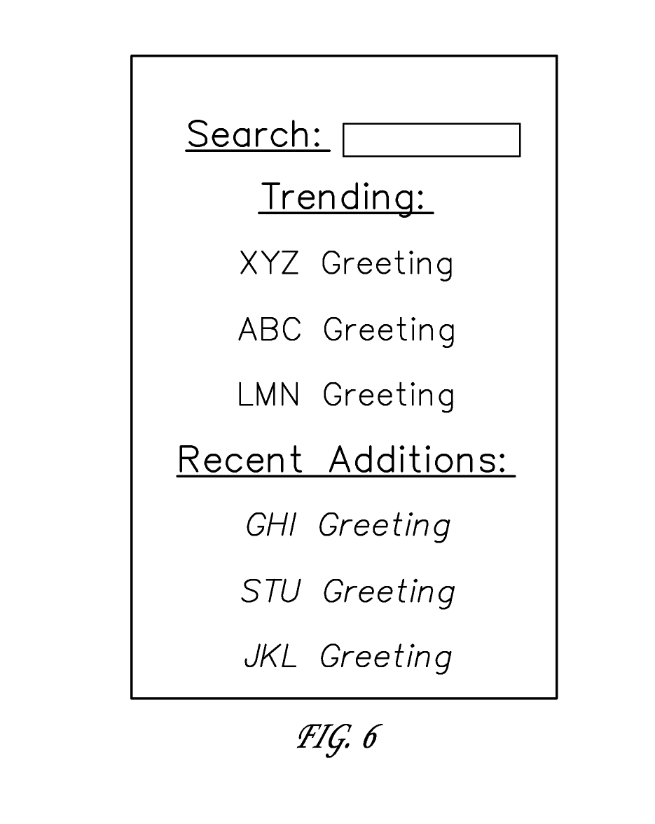

While the greeting from the audio receptionist routine obviously can be recorded by the owner/receiving party of the electronic device, it may be desirable to provide the option of selecting a pre-recorded greeting, or even to search for a suitable greeting on-line and download it into the application. Accordingly, the receptionist application can provide an on-screen options menu for selecting different greetings, such as illustrated in FIG. 5. If “Online Options” is selected from this menu, a subsequent menu similar to FIG. 6 can appear which prompts the user to search on-line for suitable greetings. The receptionist application can provide information as to which on-line greetings are currently popular (i.e. “Trending”), and information as to newly available greetings (i.e. “Recent Additions”), as depicted in FIG. 6.

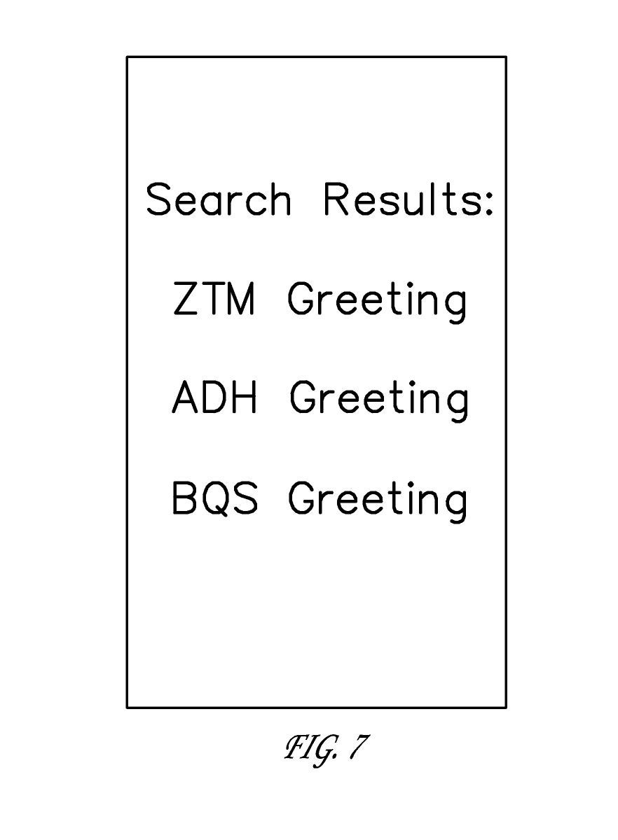

FIG. 7 is an example of an on-screen layout for providing search results for the optional greeting, from which the user can choose to download into the mobile electronic device for use by the audio receptionist routine and application.

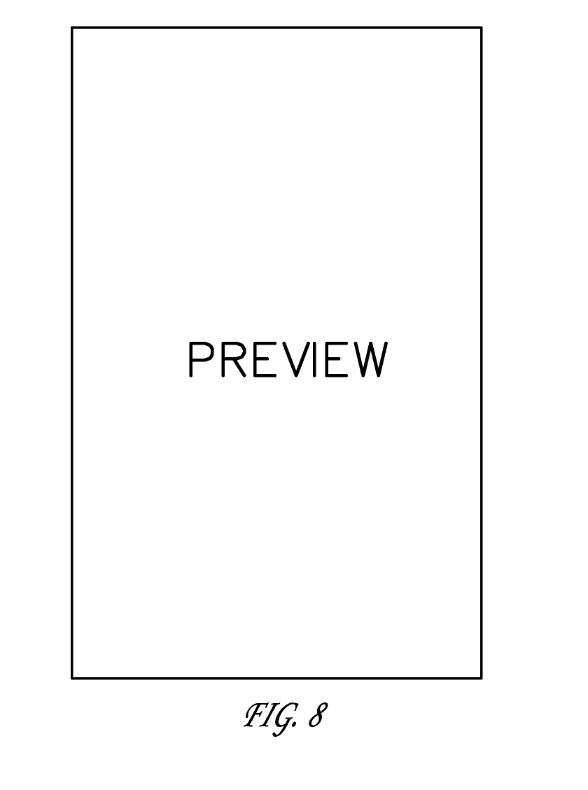

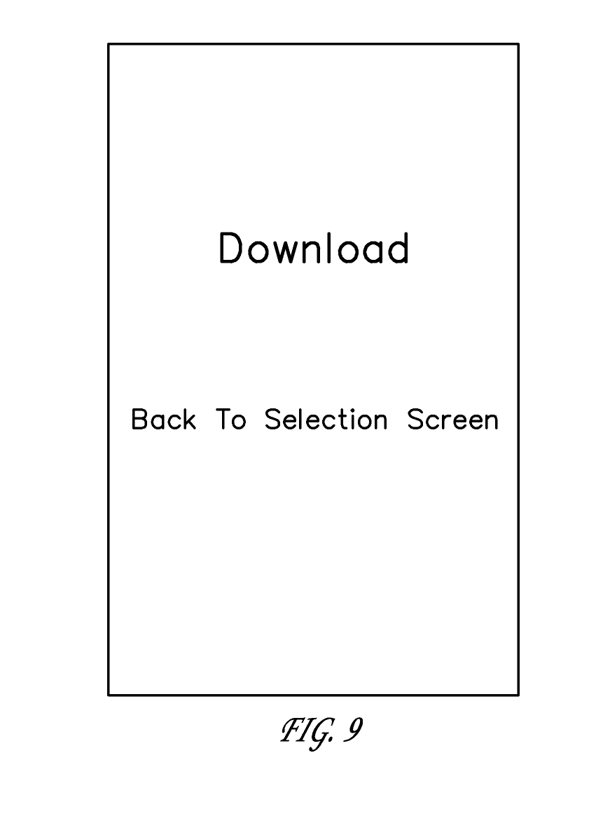

Optionally, the receptionist application can provide a preview screen, as depicted in FIG. 8, which provides the user with an audio sample of the greeting. Subsequently, the application displays a screen, as depicted in FIG. 9, which allows the user to either download the previously selected greeting, or to return to the selection screen of one or more of FIGS. 5-7, by which the user can select a different optional greeting.

The receptionist application can be resident in the mobile electronic device, such as being embedded in the firmware or its associated programs by the electronic device manufacturer, distributor, seller or the like, or the application can be downloadable into the mobile electronic device by the owner thereof, such as in the case of mobile phone applications.

In another embodiment the present invention is directed to an application for a mobile electronic device having a speaker, a visual display and a keypad, comprising a receptionist routine to screen an incoming call from a calling party to a receiving party, said program functioning to receive said incoming call, inquire of and receive information from the calling party, transmit the information to the receiving party, and provide multiple, user-selectable options to the receiving party for handling the incoming call.

In a preferred embodiment, the display of the mobile electronic device displays the multiple, user-selectable options, and the receptionist routine directs the incoming call according to selection of one of said options by the receiving party. At the user's option, the receptionist routine can be selected to engage a receptionist mode to all incoming calls, to some incoming calls or to no incoming calls.

Conveniently, the receptionist routine inquiry can be a pre-programmed message or a custom programmed message, or the receptionist routine inquiry message can be downloaded from a website for use in a mobile device. Advantageously, the receptionist routine further comprises a speech recognition routine, either resident in the application or accessed from another application, to convert verbal information received from the calling party into text for visual display to the receiving party.

The receptionist application of the present invention can be downloadable by a user, such as in the case of an application for a smart phone, or alternatively the application can be pre-programmed into the mobile electronic device, such as resident in firmware provided with the device by the manufacturer, distributor, service provider (carrier) or seller of the device.

Advantageously, the receptionist routine can be structured and arranged to receive a second incoming call during the first incoming call and conference the calls together. Obviously, the receiving party can remain in the conference call. The receptionist routine can also be structured and arranged to receive a second incoming call during the first incoming call and to allow the receiving party to terminate the first incoming call and answer the second incoming call, and/or to receive a second incoming call during the first incoming call and to allow the receiving party to send the second incoming call to a voicemail system without terminating the first incoming call.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed:

1. A process for screening an incoming call sent to a receiving party's mobile electronic device, comprising:
receiving an incoming call sent by a calling party to the receiving party's mobile electronic device;
switching the incoming call to an audio receptionist routine, programmed to inquire as to the identity of, and receive and transmit to the receiving party information from the calling party;
the audio receptionist routine providing the information to the receiving party; and
providing the receiving party's mobile electronic device with multiple, user-selectable options for handling the incoming call.

2. The process of claim 1, wherein the mobile electronic device is a mobile telephone.

3. The process of claim 1, wherein the multiple user-selectable options include answering the incoming call or sending the incoming call to voicemail.

4. The process of claim 1, wherein the multiple, user-selectable options include answering the incoming call, sending the incoming call to voicemail or terminating the incoming call.

5. The process of claim 1, wherein the multiple, user-selectable options include conferencing the incoming call with an ongoing call.

6. The process of claim 1, wherein the audio receptionist routine audibly inquires as to the name of the calling party.

7. The process of claim 1, wherein the audio receptionist routine audibly inquires as to the nature of the calling party's business.

8. The process of claim 1, wherein the audio receptionist routine transmits the information audibly to the receiving party.

9. The process of claim 1, wherein the audio receptionist routine transmits the information to the receiving party in a textual format on a display screen.

10. The process of claim 1, wherein the multiple, user-selectable options are displayed on a display screen.

11. The process of claim 1, wherein the program for the audio receptionist routine is resident in the mobile electronic device or is downloadable into the mobile electronic device.

12. An application for a mobile electronic device having a speaker, a visual display and a keypad, comprising a receptionist routine to screen an incoming call from a calling party to a receiving party, said routine functioning to receive said incoming call, inquire of and receive information from the calling party, transmit the information to the receiving party, and provide multiple, user-selectable options to the receiving party for handling the incoming call.

13. The application of claim 12, wherein the display of the mobile electronic device displays the multiple, user-selectable options.

14. The application of claim 12, wherein the receptionist routine directs the incoming call according to selection of one of said options by the receiving party.

15. The application of claim 12, wherein said receptionist routine is selected by the user to engage a receptionist mode to all incoming calls, to some incoming calls or to no incoming calls.

16. The application of claim 12, wherein said receptionist routine inquiry is a pre-programmed message or a custom programmed message.

17. The application of claim 12, wherein said receptionist routine inquiry message is downloaded from a website for use in a mobile device.

18. The application of claim 12, wherein the receptionist routine further comprises a speech recognition routine, either resident in the application or accessed from another application, to convert verbal information received from the calling party into text for visual display to the receiving party.

19. The application of claim 12, wherein the application is downloaded by a user.

20. The application of claim 12, wherein the application is pre-programmed into the mobile electronic device.

21. The application of claim 12, wherein the receptionist routine is structured and arranged to receive a second incoming call during the first incoming call and conference the calls together.

22. The application of claim 12, wherein the receptionist routine is structured and arranged to receive a second incoming call during the first incoming call and to allow the receiving party to terminate the first incoming call and answer the second incoming call.

23. The application of claim 12, wherein the receptionist routine is structured and arranged to receive a second incoming call during the first incoming call and to allow the receiving party to send the second incoming call to a voicemail system without terminating the first incoming call.
